(19) United States
(12) Patent Application Publication
(10) Pub. No.: US 2012/0072696 A1
(43) Pub. Date: Mar. 22, 2012

(54) METHOD FOR DIAGNOSING A MEMORY OF AN ELECTRONIC DEVICE

(75) Inventors: MING-RUI GUO, Shenzhen City (CN); KUN MA, Shenzhen City (CN)

(73) Assignees: HON HAI PRECISION INDUSTRY CO., LTD., Tu-Cheng (TW); HONG FU JIN PRECISION INDUSTRY (ShenZhen) Co., LTD, Shenzhen City (CN)

(21) Appl. No.: 13/177,597

(22) Filed: Jul. 7, 2011

(30) Foreign Application Priority Data
Sep. 17, 2010 (CN) 201010285085.4

(51) Int. Cl. G06F 12/10

(52) U.S. Cl. 711/203; 711/E12.068

(57) ABSTRACT

A electronic device includes a diagnosing system, a processor, a storage system, a memory, and one or more programs. The one or more programs includes a determining module, an obtaining module, a processing module, and a display module. The determining module determines whether there is a bad sector in the memory. If there is a bad sector in the memory, the determining module generates an obtaining signal. The obtaining module obtains the virtual address of the bad sector according to the obtaining signal. The processing module converts the virtual address into the corresponding physical address.

### BACKGROUND

1. Technical Field

The present disclosure relates to electronic devices, particularly, to diagnosing a bad sector of a memory of an electronic device and a method thereof.

2. Description of Related Art

Usually, a memory of a device such as a computer is diagnosed by a program executed in a user mode to find a bad sector of the memory. The program executed in the user mode is forbidden from accessing the physical address of the bad sector of the memory, thus only the virtual address can be obtained, while the physical address of the areas cannot be obtained.

Therefore, there is room for improvement in the art.

### BRIEF DESCRIPTION OF THE FIGURE

Many aspects of the embodiments can be better understood with reference to the following drawings. The components in the drawings are not necessarily drawn to scale, the emphasis instead being placed upon clearly illustrating the principles of the diagnosing system and method thereof. Moreover, in the drawings, like reference numerals designate corresponding parts throughout the several views.

FIG. 1 is a block diagram of an exemplary embodiment of an electronic device in accordance with an embodiment.

FIG. 2 is a flowchart of an exemplary embodiment of a diagnosing method in accordance with the embodiment.

### DETAILED DESCRIPTION

In general, the word “module,” as used herein, refers to logic embodied in hardware or firmware, or to a collection of software instructions, written in a programming language, for example, Java, C, or Assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will now be described in detail with reference to the drawings.

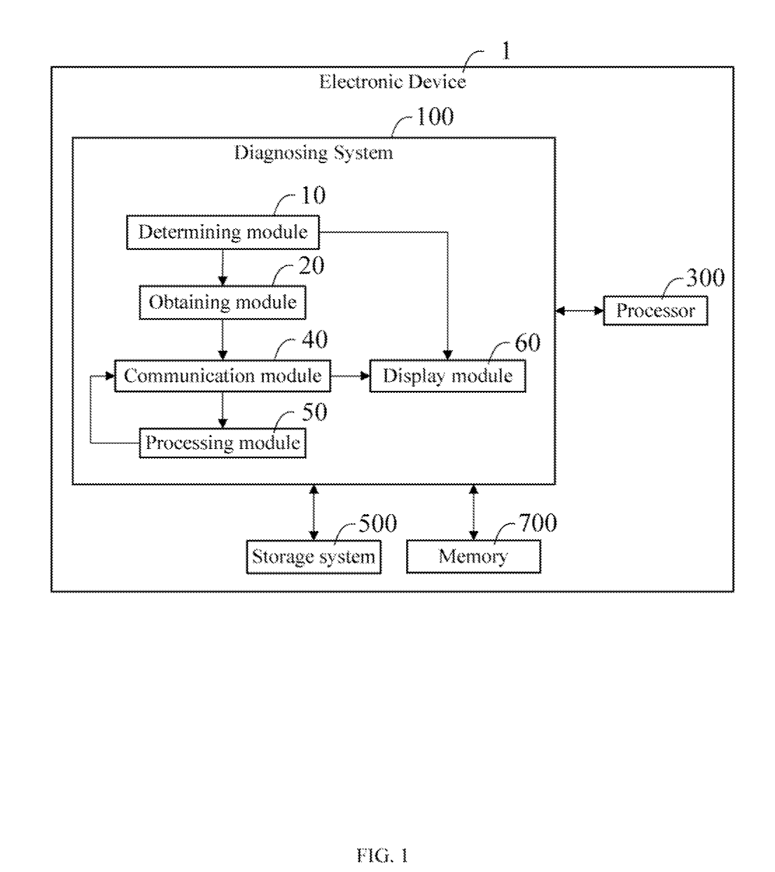

Referring to FIG. 1, an electronic device 1 such as a computer includes a diagnosing system 100, a processor 300, a storage system 500 and a memory 700. The diagnosing system 100 is used for diagnosing a bad sector of the memory 700 and includes a determining module 10, an obtaining module 20, a communication module 40, a processing module 50, and a display module 60. The modules 10-60 may comprise computerized code in the form of one or more programs that are stored in the storage system 500. The processor 300 includes a user mode and a kernel mode. The programs executed in the user mode are forbidden to use the physical addresses. The programs executed in the kernel mode can access the physical address. In the embodiment, the determining module 10, the obtaining module 20, and display module 60 are executed in the user mode, and the processing module 50 is executed in the kernel module. The diagnosing system 100 is used for diagnosing the bad sector of the memory 700. The computerized code includes instructions that are executed by the at least one processor 300 to provide functions for modules 10-60.

The processor 300 executes one or more computerized codes of the device 1 and other applications, to provide the functions of the electronic device 1.

The storage system 500 may be a read only memory (ROM), or be an external storage.

The determining module 10 determines whether there is a bad sector in the memory 700. If there is a bad sector in the memory 700, the determining module 10 generates an obtaining signal. If there is no bad sector in memory 700, the determining module 10 generates qualified information.

The display module 60 displays the qualified information on the screen of the device 1.

The obtaining module 20 obtains the virtual address of the bad sector responding to the obtaining signal.

The communication module 40 transmits the virtual address to the processing module 50. In the embodiment, the communication module 40 transmits the virtual address as an input/output (I/O) request package (IPR) to the processing module 50.

The processing module 50 converts the received virtual address into the corresponding physical address and transmits the physical address to the communication module 40.

The communication module 40 also transmits the received physical address to the display module 60.

The display module 60 also displays the physical address on a screen of the device 1.

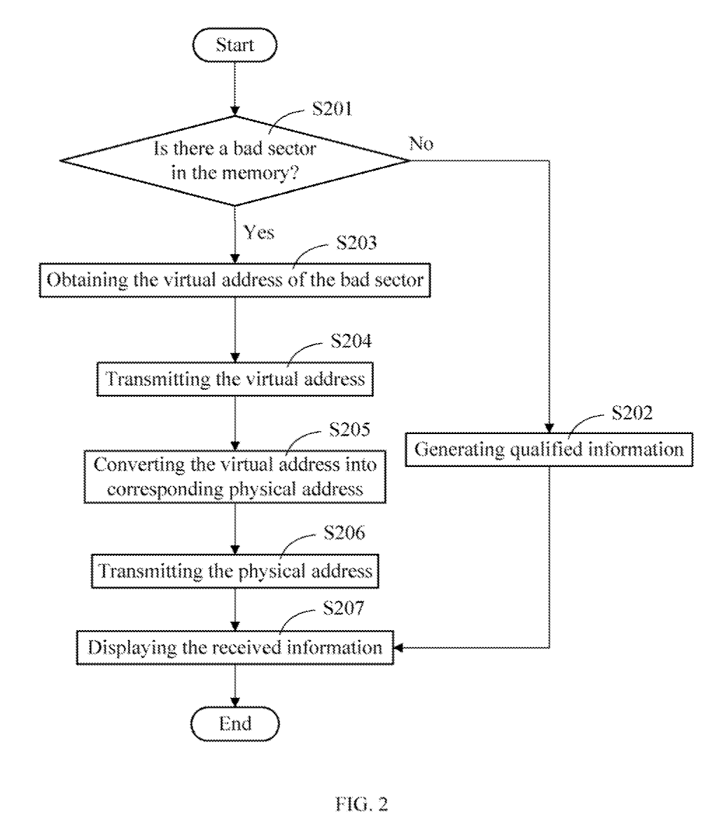

Referring to FIG. 2, a flow chart of a diagnosing method for diagnosing the physical address of bad sector of the memory 700 in the electronic device 1. The diagnosing method includes the following steps.

In step S201, in user mode the determining module 10 determines whether there is a bad sector in the memory 700. If there is no bad sector in the memory 700, the step S202 is implemented. If there is a bad sector in the memory 700, the determining module 10 generates an obtaining signal, the step S203 is implemented.

In step S202, in user mode the determining module 10 generates qualified information and the step S207 is implemented.

In step S203, in user mode the obtaining module 20 obtains the virtual address according to the obtaining signal and transmits the virtual address.

In step S204, the communication module 40 transmits the received virtual address to the processing module 50. In the embodiment, the communication module 40 transmits the virtual as an input/output (I/O) request package (IPR) to the processing module 50.

In step S205, in kernel mode the processing module 50 coverts the received virtual address into the corresponding physical address and transmits the corresponding physical address to the communication module 40.

In step S206, in user mode the communication module 40 transmits the received physical address to the display module 60.

In step S207, in user mode the display module 60 displays the received information in the screen of the device.

As described, when there is a bad sector in the memory, the diagnosing system can indicate the exact position of the memory by a physical address; people can easily analyze the reason for the bad sector in memory.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An electronic device comprising:
at least one processor, the at least one processor comprising a user mode and a kernel mode;
a storage system; and
one or more programs stored in the storage system and executable by the at least one processor, the one or more programs comprising:
a determining module adapted to determine whether there is a bad sector in a memory of the electronic device in the user mode, if there is a bad sector in the memory, the determining module generates a obtaining signal;
an obtaining module adapted to obtain a virtual address of the bad sector according to the obtaining signal in the user mode; and
a processing module adapted to convert the virtual address into a corresponding physical address in the kernel mode.

2. The electronic device of claim 1, wherein the one or more programs further comprises a communication module, and the communication module is used for transmitting the virtual address to the processing module.

3. The electronic device of claim 2, wherein the communication module transmits the virtual address as an input/output (I/O) request package.

4. The electronic device of claim 1, wherein the one or more programs further comprises a display module adapted to display the physical address in the user mode.

5. The electronic device of claim 4, wherein if there is no bad sector in the memory, the determining module generates qualified information.

6. The electronic device of claim 5, wherein the display module display the qualified information on the screen of the device.

7. A diagnosing method for diagnosing a bad sector of a memory in an electronic device, the method comprising:
determining whether there is a bad sector in the memory in user mode;
if there is a bad sector in the memory, generating a obtaining signal in user mode;
obtaining the virtual address of the bad sector in user mode; and
converting the virtual address into the corresponding physical address information in kernel mode.

8. The method according to claim 7, the electronic device comprises a communication module; after the step of obtaining the virtual address of the bad sector in user mode the step further comprising: the communication module transmits the virtual address.

9. The method according to claim 8, wherein the communication module transmits the information as an input/output (I/O) request package.

10. The method according to claim 7, wherein the after the step of converting the virtual address into corresponding physical address further comprising: the communication module transmits the corresponding physical address information; and
displaying the physical address.

11. The method according to claim 7, wherein if there is no bad sector in the memory, generating a qualified information; and
displaying the qualified information.
